(19) United States
(12) Patent Application Publication
(10) Pub. No.: US 2006/0154799 A1
(43) Pub. Date: Jul. 13, 2006

(54) Ceramic ink

(76) Inventors: Detlef Rehorek, Scheulder (NL); Maurice Theodoor Maria Schumans, Sittart (NL)

Correspondence Address: RATNERPRESTIA, P O BOX 980, VALLEY FORGE, PA, 19482-0980, US

(21) Appl. No.: 10/525,186

(22) PCT Filed: Aug. 1, 2003
(86) PCT No.: PCT/GB03/03330

§ 371 Date: Oct. 5, 2005

(30) Foreign Application Priority Data
Aug. 22, 2002 (GB) 0219583.2

(51) Int. Cl. C03C 8/14; C03C 8/16

(52) U.S. Cl. 501/17; 427/372.2; 501/20

(57) ABSTRACT

A ceramic ink comprises a glass frit, a pigment, an organic vehicle and an oxidising agent. The oxidising agent comprises a bismuth salt of nitric acid The inks provide good quality, non-stick coatings and are particularly suitable for use in the production of laminated automotive glass. A method of coating or decorating a substrate includes the step of applying the ceramic ink to the substrate.

This invention relates to ceramic inks, and in particular to ceramic inks suitable for application to automotive glass in the manufacture of laminated windscreens.

Laminated windscreens for automotive applications are formed from two sheets of glass separated by a polymeric interlayer. They are usually curved in one or often two directions, making their manufacture complex. The process is further complicated by the need to apply a coating to one or more surfaces of the laminate. Coatings may be decorative or functional. Often an edge coating is used to obscure other components or to protect the adhesive used to fix the windscreen into the body of the vehicle. Absent such an edge coating the adhesive may be subject to degradation by sunlight. Additional conductive coatings may be provided for use as antennae or as resistance heaters. The coatings are most often applied to an inner surface of one of the glass sheets making up the laminate, i.e. a surface in direct contact with the interlayer. Coating materials are usually ceramic inks or enamels and as such must be fired at elevated temperatures in order to bond them to the glass. It is important that during manufacture, the coating does not stick or transfer from one glass sheet to another.

There are several methods in use for the production of laminated windscreens. One method involves applying a coating to an inner surface of one flat glass sheet and firing the sheet to affix the coating. A second flat glass sheet is then placed on top of the coated glass such that the coating is between the sheets, and both sheets are then heated to a point where shaping can be performed. After cooling, the sheets are separated and a polymer interlayer is inserted between the glass sheets. A final heating step bonds the laminate together. The method avoids adhesion or transfer of the coating to the second glass sheet however, firing to affix the coating is both expensive and can lead to optical distortions in the final laminate.

A second method involves applying a coating to an outer surface of a first flat glass sheet and placing this glass sheet on a second flat glass sheet such that the coating remains on an outer surface. The sheets are then heated and shaped together, the heating cycle also affixing the coating to the first sheet. Once cooled, the sheets are separated and their order reversed such that the outer coated surface becomes an inner surface. Insertion and bonding of a polymer interlayer completes the process. With this method there again is no adhesion or transfer of the coating, and there is the advantage that fewer heating steps are required. A disadvantage is that small differences in curvature between the first and second glass sheets can cause stresses and optical distortions when the sheets are inverted to form the final laminate.

A third method involves applying a coating to the inner surface of a first flat glass sheet and drying the coating using a low temperature heat cycle. A second flat glass sheet is then placed on top of the first sheet such that the dried coating is between the two sheets. Both sheets are then heated and shaped, the heating cycle also affixing the coating to the first sheet. After cooling, the sheets are separated and a polymer interlayer is inserted and bonded to form the laminate. This process has the advantage that the low temperature drying cycle does not lead to optical distortions in the first sheet. It is also less expensive. The method does however place limitations of the types of coating material which can be used successfully. As the coating is only dried and not bonded to the first glass sheet prior to shaping, adhesion and transfer may occur. Furthermore, coating compositions contain organic vehicles to facilitate application by printing; such organic components are not completely driven off during drying. In the case of the first two methods described above, the organic content of the coating does not give rise to problems as it is easily oxidised during one of the high temperature heat cycles. This is because, at least once, the coating is on a surface exposed to the atmosphere (air) when at high temperature. In the third method, organic components are trapped between the glass sheets when at high temperature, and thus have no access to atmospheric oxygen. Nevertheless, this third method is generally preferred industrially.

U.S. Pat. No. 5,443,669 addresses the problems encountered using the third method described above by providing a ceramic ink incorporating an organic vehicle which has high volatility, and an optional oxygen-releasing agent. The vehicle is largely evaporated during drying and, at elevated temperature during shaping, the agent provides the required oxygen to oxidise (burn-out) any remaining organic material in the ink. The present applicants have found however, that inks containing low volatility organic vehicles are problematic to print, and that the suggested oxygen-releasing agents, lead dioxide, red lead and manganese dioxide are both detrimental to the fluid properties of inks and result in poor quality coatings. The printing properties of the inks can be improved by adding polymeric species however, vehicles containing high amounts of polymers have a tendency not to burn-out satisfactorily, even in the presence of the above mentioned oxygen-releasing agents.

There is thus a requirement for a ceramic ink incorporating conventional organic vehicles which is able to provide good quality coatings suitable for use in the production of laminated glass products.

In accordance with the present invention, a ceramic ink comprises a glass frit, a pigment, an organic vehicle and an oxidising agent; wherein the oxidising agent comprises a bismuth salt of nitric acid.

Preferably, the oxidising agent comprises one or more species chosen from; BiONO₃, Bi₅O(OH)₉(NO₃)₄, BiONO₃.H₂O and Bi(NO₃)₃.xH₂O.

Surprisingly, it has been found that the heretofore mentioned bismuth salts lead to more efficient and complete burn-out and do not adversely affect the fluid properties of conventional organic vehicles, such as common screen printing media. This is in contrast to compounds such as manganese dioxide.

The bismuth salts used in the present invention are effective to oxidise the organic component of the inks at temperatures between 500 and 600° C. This temperature is similar to that conventionally used in the shaping process. The oxygen-releasing agents of U.S. Pat. No. 5,443,669 described above, all provide oxygen at temperatures between 300 and 450° C. This temperature is too low to allow the glass to be shaped and also too low for the complete burn-out of organic polymers.

WO 97/36836 and U.S. Pat. No. 3,973,975 relate to the use of inter alia bismuth compounds in sealing glass applications. These compounds prevent the reduction of PbO to metallic lead in the leaded sealing glasses used for television tube manufacture. Sealing glasses do not contain any pigment, nor are they used in conditions where atmospheric oxygen is absent.

The amount of oxidising agent in the ink is dependent on the amount of organic vehicle present. Suitably, the oxidising agent comprises 0.5 to 20 wt % of the ink.

The glass frit may be any glass frit commonly used in ceramic inks and may be crystallising or non-crystallising. A crystallising frit is preferred. Some specific but non-limiting examples include frits B5236MF, B5316F, B5317F, B5318F, R5408F and 5409F, all of which are commercially available from Johnson Matthey PLC. Preferably, the glass frit comprises a low melting glass frit with a softening point between 480 and 550° C. The glass frit may be a single frit or any mixture of two or more frits.

In a particularly preferred embodiment, the glass frit comprises a bismuth-containing frit. The addition of a bismuth salt to a bismuth-containing frit aids crystallisation of the frit.

Suitable pigments include any pigments commonly used in ceramic inks. Some non-limiting examples include copper chromite(III), iron-manganese oxide and iron-chromium-manganese-nickel oxide. At the present time, most of the pigments used in ceramic inks for laminated glass products are black in colour however, this is largely driven by customer requirements and as such it is not intended that the present invention be limited to inks based on black pigments. Other coloured pigments commonly used for glass enamels may equally be used and include by way of example, manganese-antimony-titanium oxide brown pigments, chromium(III) oxide green pigments, cobalt-zinc aluminate blue pigments and zircon vanadate turquoise pigments. The pigment suitably comprises between 10 and 40 wt % of the ink. Pigments may be added individually or as any suitable mixture of two or more pigments.

In order to improve crystallisation during the firing process, additional seed materials may be added to the ink. The type of seed material to be added depends on the actual frit used in the ink. Examples of seed materials that may be added include bismuth silicates, bismuth titanates, titania, silica, other glass frits and pigments. Typically, the amount of seed material comprises 0.5 to 10 wt % of the ink.

Preferably, the organic vehicle comprises a screen printing medium. Suitable vehicles include solutions of polymethacrylates of lower alcohols, polyacrylates, poly(N-vinyl pyrrolidone), poly(vinyl butyral), alkoxylated cellulose derivatives such as ethyl cellulose, ethyl hydroxyethyl cellulose and phenolic resins in solvents, provided that the solvents have boiling points high enough in order to prevent too rapid drying during printing whilst being sufficiently volatile to allow drying at reasonably low temperatures. Some suitable solvents include pine oil, alpha- or beta-terpineol, high boiling alcohols such as isotridecanol and glycol derivatives. The screen printing medium may also contain additives such as thixotropic agents and wetting agents. Some specific examples of suitable screen printing media are ST725 and ST736 which are commercially available from Johnson Matthey PLC. Mixtures of two or more organic vehicles are also included within the scope of the present invention.

The inks may contain further additives as is known in the art. For example, wetting agents such as lecithin or thickeners such as fumed silica may be added.

The inks of the present invention may be applied by any suitable method and to any suitable substrate. They are particularly suitable for use in the manufacture of laminated glass products such as automotive glass and the like. Other uses and applications will however be apparent to those skilled in the art.

The invention will now be described by way of example only.

### EXAMPLE 1

An ink was prepared by blending 63 parts by weight of a low-melting crystallising glass frit R5409F (Johnson Matthey PLC), 10 parts by weight bismuth subnitrate, Bi₅O(OH)₉(NO₃)₄, 5 parts by weight seed material SP83-1F (Johnson Matthey PLC) and 22 parts by weight copper chromite(III) black pigment with 20 parts by weight of screen-printing medium ST736 (Johnson Matthey PLC). This blend was thoroughly mixed and dispersed by three-roll milling.

The ink was printed onto a flat glass plate by screen-printing using a 90T polyester screen and dried in air at ca. 130-150° C. A second undecorated glass plate was then placed on top of the first plate such that the dried ink was between the glass plates, and both plates were fired together on a belt furnace at 570° C. for ca. 6 minutes.

After firing, the plates could easily be separated. A homogenous, defect free black ceramic decoration having a smooth surface was obtained, with no visible transfer of the decoration to the second plate.

### EXAMPLE 2

An ink was prepared by blending 50 parts by weight of low-melting bismuth-containing frit B5317F (Johnson Matthey PLC), 5 parts by weight of crystallising frit R5408F (Johnson Matthey PLC), 34 parts by weight copper chromite(III) black pigment and 11 parts by weight bismuth nitrate (BiONO₃) with 20 parts by weight screen-printing medium ST725 and subsequent three-roll milling.

This ink was screen-printed onto a glass plate through a 90 T screen. After drying at ca. 130-150° C. a second glass plate was placed on top of the decorated plate and both plates were fired at 570° C. for ca. 6 minutes.

Although the glass plate showed a homogeneous colour and a well fused enamel, some sticking between the bottom and top glass plates was observed.

### EXAMPLE 3

An ink was prepared by blending 28 parts by weight of low-melting bismuth-containing frit B5317F having a softening point below 500° C. (Johnson Matthey PLC), 15 parts by weight of crystallising frit B5236MF having a softening point of 535° C. (Johnson Matthey PLC), 20 parts by weight of non-crystallising glass frit B5318F having a softening point of 550° C. (Johnson Matthey PLC), 25 parts by weight copper chromite(III) black pigment, 10 parts by weight bismuth nitrate (BiONO₃) and 2 parts by weight of seed material SP83-1F (Johnson Matthey PLC) with 20 parts by weight screen-printing medium ST725 and subsequent three-roll milling.

This ink was screen-printed onto a glass plate through a 90 T screen. After drying at ca. 130-150° C. a second glass plate was placed on top of the decorated plate and both plates were fired at 570° C. for ca. 6 minutes.

After firing, the plates could easily be separated. A homogenous, defect free black ceramic decoration having a smooth surface was obtained, with no visible transfer of the decoration to the second plate.

### EXAMPLE 4

6 parts by weight of the ink prepared in example 2 and 4 parts by weight of the ink prepared in example 3 were mixed and printed onto a glass plate. After drying at ca. 130° C., a second glass plate was placed on top of the first plate and both plates were fired at 570° C. for ca. 6 minutes.

After firing, the plates could easily be separated. A homogenous, defect free black ceramic decoration having a smooth surface was obtained, with no visible transfer of the decoration to the second plate.

### COMPARATIVE EXAMPLE

A screen-printing ink was prepared absent any bismuth salt of nitric acid. The ink comprised 73 parts by weight of a low-melting crystallising glass frit R5409F (Johnson Matthey PLC), 5 parts by weight seed material SP83-1F (Johnson Matthey PLC) and 22 parts by weight copper chromite(III) black pigment with 20 parts by weight of screen-printing medium ST736 (Johnson Matthey PLC) and was prepared by the same route as described in Example 1.

This ink was applied by screen-printing through a 90T polyester screen onto a glass plate. After drying, a second glass plate was placed on top of this plate. Both plates were fired at 570° C. for ca. 6 minutes.

Unlike in examples 1 to 4, the colour of the glass enamel, when viewed from the glass side, was not homogeneous. Whilst the edges of the enamelled area were fired satisfactorily, the centre exhibited grey spots indicative of incomplete burn-out. In addition, the enamel surface was very rough in the centre of the enamelled area, and some sticking was observed at the edges and at the corners of the plates.

1. A ceramic ink, the ink comprising a glass frit, a pigment, an organic vehicle and an oxidising agent, wherein the oxidising agent comprises a bismuth salt of nitric acid.

2. The ink according to claim 1, wherein the oxidising agent comprises a species selected from the group consisting of at least one of BiONO₃, Bi₅O(OH)₉(NO₃)₄, BiONO₃.H₂O and Bi(NO₃)₃.xH₂O.

3. The ink according to claim 1, wherein the oxidising agent comprises 0.5 to 20 wt % of the ink.

4. The ink according to claim 1, wherein the glass frit has a softening point of between 480 and 550° C.

5. The ink according to claim 1, wherein the glass frit comprises a bismuth containing frit.

6. The ink according to claim 1, wherein the pigment is selected from the group consisting of at least one of copper chromite(III), iron manganese oxide and iron chrome manganese nickel oxide.

7. The ink according to claim 1, wherein the pigment comprises 10-40 wt % of the ink.

8. The ink according to claim 1, comprising a seed material selected from the group consisting of at least one of bismuth silicates, bismuth titanates, titania, silica, other glass frits and pigments.

9. The ink according to claim 8, wherein the seed material comprises 0.5-10 wt % of the ink.

10. The ink according to claim 1, wherein the organic vehicle comprises a screen printing medium.

11. A substrate coated or decorated using an ink according to claim 1.

12. A laminated glass product comprising a coating or decoration; wherein the coating or decoration is applied using an ink according to claim 1.

13. A method of coating or decorating a substrate, the method comprising
applying a ceramic ink to a substrate, followed by drying and firing; wherein the ink comprises a glass frit, a pigment, an organic vehicle and an oxidising agent, wherein the oxidising agent comprises a bismuth salt of nitric acid.

14. The method according to claim 13, wherein the substrate is glass.
